(19) United States
(12) Patent Application Publication
(10) Pub. No.: US 2017/0355560 A1
(43) Pub. Date: Dec. 14, 2017

(54) SYSTEM AND METHOD FOR MONITORING ELEVATOR BRAKE CAPABILITY

(71) Applicant: Otis Elevator Company, Farmington, CT (US)

(72) Inventors: Peter Herkel, Berlin (DE); Frank Kirchhoff, Berlin (DE)

(21) Appl. No.: 15/528,999

(22) PCT Filed: Nov. 23, 2015
(86) PCT No.: PCT/US2015/062144

§ 371 Date: May 23, 2017

Related U.S. Application Data
(60) Provisional application No. 62/084,072, filed on Nov. 25, 2014.

(51) Int. Cl. B66B 5/00; B66D 5/30; B66B 1/34

(52) U.S. Cl. CPC B66B 5/0037; B66D 5/30; B66B 1/34; B66B 5/0031

(57) ABSTRACT

An elevator brake monitoring system includes a car (12); a machine (18) configured to actuate movement of the car; and a brake (32) configured to decelerate the car; wherein the system is configured to operate the machine to move the car at a pre-determined speed, engage the brake, measure a braking parameter and compare the measured braking parameter to a reference braking parameter.

### BACKGROUND OF INVENTION

The invention relates generally to an elevator and, more specifically, to a system and method for monitoring the capability of a brake of the elevator to sufficiently decelerate the elevator during emergency stopping thereof.

An elevator brake may be tested periodically to assure that the brake has sufficient braking capability (i.e., the capability of the brake to decelerate and stop an elevator car). In older elevators, the braking capability is readily determined because the brake is used to actively control the elevator car during normal operations. For example, the braking capability may be tested implicitly at each stop of the car by verifying that the elevator decelerates and/or levels as expected when the brake is applied.

Modern elevators use a motor to both decelerate the elevator car and hold the elevator car in position (e.g., at a landing). In modern elevators, normal deceleration and leveling of the elevator car may be performed by varying drive signals applied to the motor. The brake is typically engaged only in certain situations to hold or secure the elevator car in a stopped position. Thus, the brake capability is not easily detectable or verifiable through normal use. Brake shoe tests are part of regular safety code required tests. During these tests, a service person activates/deactivates the individual brake shoes. These tests are cumbersome and put excessive strain on the brake, leading to an accelerated decline of the brake capability.

### BRIEF DESCRIPTION OF INVENTION

According to an exemplary embodiment of the invention, an elevator brake monitoring system includes a car; a machine configured to actuate movement of the car; and a brake configured to decelerate the car; wherein the system is configured to operate the machine to move the car at a pre-determined speed, engage the brake, measure a braking parameter and compare the measured braking parameter to a reference braking parameter.

In addition to one or more of the features described above or below, or as an alternative, further embodiments may include the measured braking parameter being braking distance.

In addition to one or more of the features described above or below, or as an alternative, further embodiments may include the system being configured to determine the braking distance in response to the position encoder.

In addition to one or more of the features described above or below, or as an alternative, further embodiments may include the measured braking parameter being braking time.

In addition to one or more of the features described above or below, or as an alternative, further embodiments may include the system being configured to determine a braking capability of the brake in response to comparing the measured braking parameter to the reference braking parameter.

In addition to one or more of the features described above or below, or as an alternative, further embodiments may include the braking capability being unsatisfactory when the measured braking parameter exceeds the reference braking parameter.

In addition to one or more of the features described above or below, or as an alternative, further embodiments may include the braking capability being satisfactory when the measured braking parameter is below the reference braking parameter.

In addition to one or more of the features described above or below, or as an alternative, further embodiments may include the braking capability being stored locally or in an external service system.

In addition to one or more of the features described above or below, or as an alternative, further embodiments may include the measured braking parameter being stored locally or in an external service system.

According to another r exemplary embodiment of the invention, a method for monitoring a braking capability of a brake of an elevator, the elevator including a car, a machine configured to actuate movement of the car, and the brake configured to decelerate the car, the method including operating the machine to move the car at a predetermined speed; engaging the brake; measuring a braking parameter; and comparing the measured braking parameter to a reference braking parameter.

In addition to one or more of the features described above or below, or as an alternative, further embodiments may include the measured braking parameter being braking distance.

In addition to one or more of the features described above or below, or as an alternative, further embodiments may include the measured braking parameter being braking time.

In addition to one or more of the features described above or below, or as an alternative, further embodiments may include determining a braking capability of the brake in response to comparing the measured braking parameter to the reference braking parameter.

In addition to one or more of the features described above or below, or as an alternative, further embodiments may include the braking capability being unsatisfactory when the measured braking parameter exceeds the reference braking parameter.

In addition to one or more of the features described above or below, or as an alternative, further embodiments may include the braking capability being satisfactory when the measured braking parameter is below the reference braking parameter.

In addition to one or more of the features described above or below, or as an alternative, further embodiments may include storing the braking capability locally or in an external service system.

In addition to one or more of the features described above or below, or as an alternative, further embodiments may include storing the measured braking parameter locally or in an external service system.

In addition to one or more of the features described above or below, or as an alternative, further embodiments may include emptying the car of load prior to operating the machine to move the car at the predetermined speed.

A technical effect of the invention is the ability to automatically test the braking capability of an elevator brake without requiring service personnel to visually and/or physically inspect the brake. Results of the braking capability test may be stored and notifications and/or reports may be generated based on the braking capability test.

### BRIEF DESCRIPTION OF DRAWING

The subject matter that is regarded as the invention is particularly pointed out and distinctly claimed in the claims at the conclusion of the specification. The foregoing and other features and advantages of the invention are apparent from the following detailed description taken in conjunction with the accompanying drawing in which:

FIG. 1 is a perspective view of an elevator in which an elevator brake monitoring system according to an exemplary embodiment may be implemented;

FIG. 2 is a perspective view of a machine for controlling movement of an elevator car in an exemplary embodiment; and

FIG. 3 is a flow diagram of a method for monitoring the braking capability of a brake of the machine illustrated in FIG. 2 in an exemplary embodiment.

### DETAILED DESCRIPTION OF INVENTION

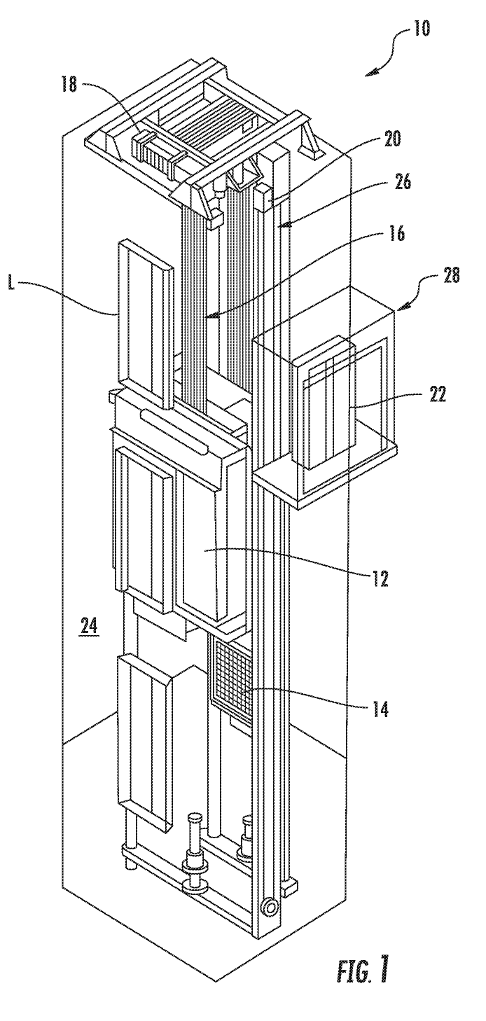

FIG. 1 is a perspective view of an elevator 10 including a car 12, a counterweight 14, roping 16, a machine 18, a position encoder 20, and a controller 22. The car 12 and counterweight 14 are connected to each other by the roping 16. The roping 16 may include, for example, ropes, steel cables, or coated-steel belts. The counterweight 14 balances a load from the car 12 and facilitates movement of the car 12 concurrently and in an opposite direction with respect to the counterweight 14 within a hoistway 24.

The roping 16 engages the machine 18, which is part of an overhead structure of the elevator 10 and controls movement between the car 12 and counterweight 14. The position encoder 20 may be mounted on an upper sheave of a speed-governor system 26 and configured to provide position signals related to a position of the car 12 within the hoistway 24. In other embodiments, the position encoder 20 may be directly mounted to a moving component of the machine 18.

The controller 22 is located, for example, in a controller room 28 of the hoistway 24 and controls operation of the elevator 10. The controller 22 provides drive signals to the machine 18 to control the acceleration, deceleration, leveling, and stopping of the car 12. The controller 22 is also configured to receive the position signals from the position encoder 20.

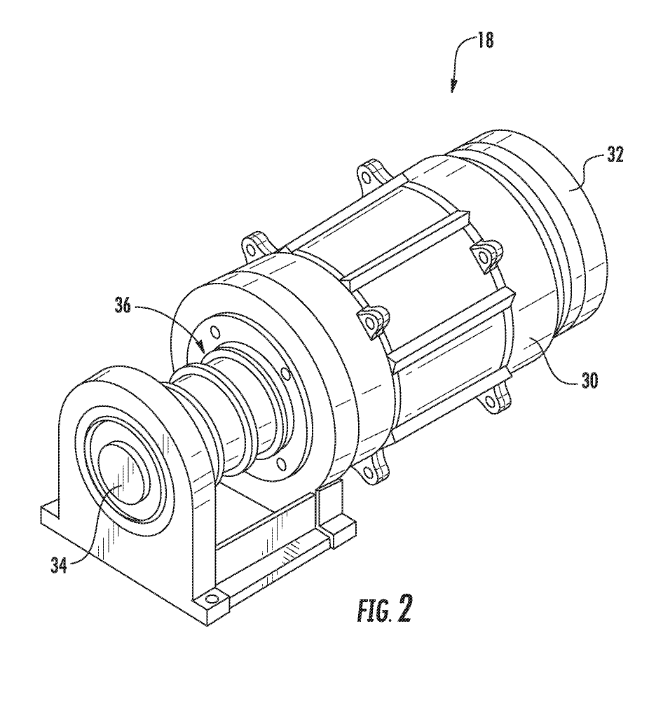

FIG. 2 is a perspective view of the machine 18 for controlling the movement of the car 12 and the counterweight 14. The machine 18 includes a motor 30, a brake 32, a rotating member 34, and a sheave 36. In an exemplary embodiment, the rotating member 34 is a drive shaft 34 that projects from the motor 30. The sheave 36 is fixedly disposed on the drive shaft 34 and mechanically engages the roping 16. The brake 32 is disposed adjacent to the motor 30 at an end of the drive shaft 34 opposite the sheave 36. It should be readily appreciated that the brake 32 can have any suitable relationship with the motor 30, the drive shaft 34, and the sheave 36.

The drive shaft 34 is rotatably driven by the motor 30, which causes the sheave 36 to rotate. This rotation causes linear movement of the car 12 and the counterweight 14 due to the engagement between the roping 16 and the sheave 36. The motor 30 drives the drive shaft 34 based upon the drive signals received from the controller 22. The magnitude and direction of the force (i.e., torque) provided by the motor 30 on the roping 16 controls the acceleration, deceleration, direction, and speed of the car 12. When the brake 32 engages the drive shaft 34, the car 12 is stopped or secured in place to prevent movement of the car 12.

It should be readily appreciated that the brake 32 can be any suitable type of brake and engage and disengage from the drive shaft 34 in any suitable manner. It should be readily appreciated as well that, although the elevator 10 is disclosed herein as including the rotating sheave 36 and motor 30, the elevator 10 can be implemented with other drive systems, such as a linear motor-driven elevator (e.g., a ropeless, self-propelled elevator). Embodiments are not limited to use of the machine 18 of FIG. 2.

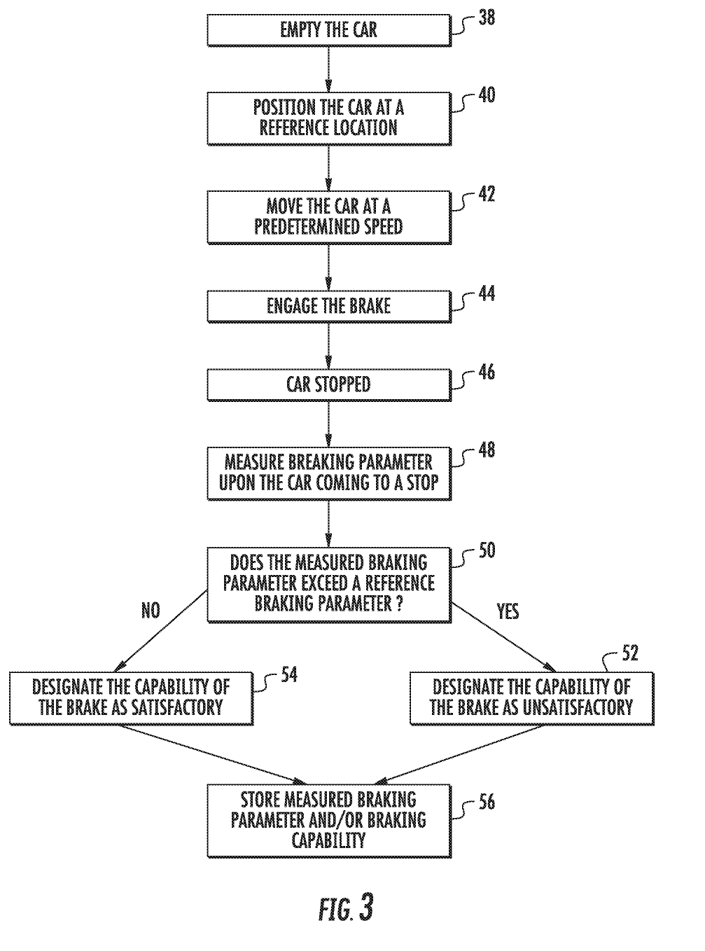

FIG. 3 is a flow diagram for a method for monitoring the braking capability of the brake 32 to sufficiently decelerate the car 12 according to an exemplary embodiment of the invention. With the method, an automatic test of the braking capability is initiated under defined conditions.

At step 38, the car 12 is emptied of load to provide a consistent mass. It is understood that the braking capability test may be performed with a load in the car 12. It is desirable, however, to use the same car load across multiple braking capability tests. Emptying car 12 is just one example of a technique to provide a consistent mass. The elevator 10 may include, for example, at least one weight sensor to determine when there is no load in the car 12. At step 40, the unloaded car 12 is positioned in the hoistway 24 at a reference position (for instance, at an upper landing L of the hoistway 24). It is understood that step 40 may precede step 38. The reference position is used so that subsequent braking capability tests are performed under similar circumstances.

At step 42, the machine 18 is operated to move the car 12 at a predetermined speed. More specifically, the motor 30 drives the drive shaft 34 and sheave 36 to provide movement of the car 12 at the predetermined speed. In an exemplary embodiment, the predetermined speed is less than or equal to a nominal speed of the car 12 during normal operations. In an exemplary embodiment, the nominal speed is about one meter/second, and the predetermined speed is about half of the nominal speed. The motor 30 drives the drive shaft 34 and sheave 36 for a short period of time (e.g., not more than a few seconds). In this way, noise and wear of the brake 32 are maintained at a low level during the test.

It should be readily appreciated that the nominal speed can be any suitable speed and the predetermined speed can be any suitable speed that is less than or equal to the nominal speed. For example, the predetermined speed may vary from about 20% of the nominal speed to about 70% of the nominal speed.

Once the car 12 is traveling at the predetermined speed, the brake 32 is engaged as shown at step 44. More specifically, the controller initiates the brake 32 to decelerate the car 12 in a simulated “emergency” stop condition.

At step 46, the brake 32 has decelerated the car 12 to a completely stopped position. At step 48, a measured braking parameter is determined by the controller 22. It is understood that step 48 may be performed concurrently as the car 12 decelerates, and step 48 need not occur until after the car 12 has come to a stop. The measured braking parameter may be a braking distance the car 12 traveled from the application of the brake 32 at step 44 to the stopping of the car 12 at step 46. The controller 22 may use position signals from position encoder 20 to determine the braking distance traveled from the application of the brake 32 at step 44 to the stopping of the car 12 at step 46. In another exemplary embodiment, the measured braking parameter may be a braking time elapsed from the application of the brake 32 at step 44 to the stopping of the car 12 at step 46. The controller 22 may use an internal clock to determine the braking time from the application of the brake 32 at step 44 to the stopping of the car 12 at step 46.

At step 50, the measured braking parameter is compared to a reference braking parameter. If the measured braking parameter exceeds the reference braking parameter, flow proceeds to step 52 where the braking capability of the brake 32 is designated as unsatisfactory. This indicates that the measured braking parameter was excessive (e.g., too long of a distance or too long of a time to bring the car to a stop). At step 50, if the measured braking parameter does not exceed the reference braking parameter, flow proceeds step 54 where the braking capability of the brake 32 is designated as satisfactory.

At step 56, the measured braking parameter can be stored locally on controller 22 or at an external service system. The braking capability determined through step 50 (e.g., satisfactory or unsatisfactory) may also be stored locally on controller 22 or at an external service system. A report including the results of the brake test of FIG. 3 may be generated periodically to provide proof of compliance with certain regulations or codes requiring brake inspection. An alert or notification may be generated if the measured braking parameter exceeds the reference braking parameter to notify service personnel to inspect brake 32.

The exemplary system and method allow for automatic monitoring of performance of the brake 32 by applying the brake 32 and measuring stopping distance/time of the elevator car 12 under defined test conditions. The exemplary system and method allow for the brake 32 to be monitored regularly (e.g., every day). In addition, the exemplary system and method allow for simplification of maintenance and service of the elevator 10 since the exemplary system and method do not require a mechanic to perform a brake test. Moreover, the exemplary system and method allow for early and regular diagnostics of performance of the brake 32.

While the invention has been described in detail in connection with only a limited number of embodiments, it should be readily understood that the invention is not limited to such disclosed embodiments. Rather, the invention can be modified to incorporate any number of variations, alterations, substitutions, or equivalent arrangements not heretofore described, but which are commensurate with the spirit and scope of the invention. Additionally, while various non-limiting embodiments of the invention have been described, it is to be understood that aspects of the invention may include only some of the described embodiments. Accordingly, the invention is not to be seen as limited by the foregoing description, but is only limited by the scope of the appended claims.

1. An elevator brake monitoring system comprising:
a car;
a machine configured to actuate movement of the car; and
a brake configured to decelerate the car, wherein the system is configured to operate the machine to move the car at a pre-determined speed, engage the brake, measure a braking parameter and compare the measured braking parameter to a reference braking parameter.

2. The elevator brake monitoring system of claim 1, wherein the measured braking parameter is braking distance.

3. The elevator brake monitoring system of claim 2, further comprising a position encoder, the system configured to determine the braking distance in response to the position encoder.

4. The elevator brake monitoring system of claim 1, wherein the measured braking parameter is braking time.

5. The elevator brake monitoring system of claim 1, wherein the system is configured to determine a braking capability of the brake in response to comparing the measured braking parameter to the reference braking parameter.

6. The elevator brake monitoring system of claim 5, wherein the braking capability is unsatisfactory when the measured braking parameter exceeds the reference braking parameter.

7. The elevator brake monitoring system of claim 5, wherein the braking capability is satisfactory when the measured braking parameter is below the reference braking parameter.

8. The elevator brake monitoring system of claim 5, wherein the braking capability is stored locally or in an external service system.

9. The elevator brake monitoring system of claim 1, wherein the measured braking parameter is stored locally or in an external service system.

10. A method for monitoring a braking capability of a brake of an elevator, the elevator including a car, a machine configured to actuate movement of the car, and the brake configured to decelerate the car, the method comprising:
operating the machine to move the car at a predetermined speed;
engaging the brake;
measuring a braking parameter; and
comparing the measured braking parameter to a reference braking parameter.

11. The method of claim 10, wherein the measured braking parameter is braking distance.

12. The method of claim 10, wherein the measured braking parameter is braking time.

13. The method of claim 10, further comprising determining a braking capability of the brake in response to comparing the measured braking parameter to the reference braking parameter.

14. The method of claim 13, wherein the braking capability is unsatisfactory when the measured braking parameter exceeds the reference braking parameter.

15. The method of claim 13, wherein the braking capability is satisfactory when the measured braking parameter is below the reference braking parameter.

16. The method of claim 13, further comprising storing the braking capability locally or in an external service system.

17. The method of claim 10, further comprising storing the measured braking parameter locally or in an external service system.

18. The method of claim 10, further comprising emptying the car of load prior to operating the machine to move the car at the predetermined speed.
